(19) United States
(12) Patent Application Publication
(10) Pub. No.: US 2023/0186570 A1
(43) Pub. Date: Jun. 15, 2023

(54) METHODS AND SYSTEMS TO ALLOW THREE-DIMENSIONAL MAPS SHARING AND UPDATING

(71) Applicant: META PLATFORMS TECHNOLOGIES, LLC, Menlo Park, CA (US)

(72) Inventors: Zachary Michael Moratto, Marina Del Rey, CA (US); Kevin Joseph Sheridan, Redwood City, CA (US); Cheyne Mathey-Owens, Seattle, WA (US); Adam Ritenauer, Seattle, WA (US)

(21) Appl. No.: 17/548,203

(22) Filed: Dec. 10, 2021

(51) Int. Cl. G06T 19/00; G06V 10/40; G06T 7/73

(52) U.S. Cl. CPC G06T 19/006; G06V 10/40; G06T 7/73

(57) ABSTRACT

A method includes generating a local map of a real environment, the local map being defined by first spatial relationships between first feature descriptors corresponding to a visible feature in the real environment captured by a device. The device receives a downloaded map defined by second spatial relationships between an anchor point and second feature descriptors corresponding to visible features captured by another device, wherein the anchor point corresponds to a location of a virtual object. The local map is updated by merging the downloaded map with the local map based on a comparison between the first feature descriptors and the second feature descriptors and a pose of the device is determined relative to a particular feature descriptor in the updated local map. Virtual content is rendered based on the pose and one or more spatial relationships linking the particular feature descriptor and the anchor in the updated local map.

### TECHNICAL FIELD

This disclosure generally relates to facilitating access to three-dimensional maps.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Disclosed methods provide techniques for sharing and merging map updates with a feature map stored on an artificial reality device. A device may receive an update to a feature map, which may include one or more anchor points and/or other information about the environment. The update may be a subgraph of a hierarchical map structure, which comprises the anchor point of interest and one or more other portions of the feature map in order to locate and merge the updated map data with the feature map stored on the artificial reality device. Particular anchor points may provide virtual content that can be interacted with in an artificial reality environment (e.g., advertisements, navigational instructions points of interest (POIs), etc.). The updated map data is merged into the feature map stored on the device. Once merged, virtual content can be rendered and displayed a user of the device using the updated map data which has been merged into the feature map stored on the device. In particular embodiments, the device may persistently adjust the location of the anchor points in the artificial reality environment as the user of the device approaches one or more anchor points in the artificial reality environment. Adjusting the position of the anchor point may be based on comparing one or more feature descriptors in the received subgraph with one or more feature descriptors present at the second location. Adjustment may become particularly important as a user of a device approaches or seeks to interact with a particular anchor point in the artificial reality environment. For example, when a user of a device is distanced from the anchor point (e.g., more than 10 meters away) any errors in the positioning of the anchor point are often insignificant and imperceivable to the user. However, as the user approaches the particular point after merging the data with the feature map, these errors may become significant. Adjusting as the user approaches one or more anchor points creates an accurate and more immersive experience.

In particular embodiments, the map data may be generated and shared by one or more components (e.g., CPU, GPU, etc.) of a computing system associated with a device (e.g., a laptop, a cellphone, a desktop, a wearable device). In particular embodiments, the device is in communication with a computing system on the HMD but may be otherwise physically separated from the HMD. As an example and not by way of limitation, this device may be a laptop device that is wired to the HMD or communicates wirelessly with the HMD. As another example and not by way of limitation, the device may be a wearable (e.g., a device strapped to a wrist), handheld device (e.g., a phone), or some other suitable device (e.g., a laptop, a tablet, a desktop) that is wired to the HMD or communicates wirelessly with the HMD. As another example and not by way of limitation, an onboard computing system of an HMD may generate and share the map data between one or more other devices.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system and user.

FIG. 1B illustrates an example augmented reality system.

FIG. 2 illustrates a spatial representation of a feature map, which may include one or more nodes that define a particular area.

FIG. 3 illustrates an example hierarchical graph structure for a particular feature map.

FIG. 4 illustrates an example anchor point for facilitating placement of a virtual object in an artificial reality environment.

FIGS. 5A-5F illustrate a sample process for sharing and merging feature maps between artificial reality devices.

FIG. 6 illustrates a sample process for updating a feature map stored on an artificial reality device.

FIG. 7 illustrates an example method for displaying virtual objects in an artificial reality environment based on a merged map.

FIG. 8 illustrates an example network environment associated with a social-networking system.

FIG. 9 illustrates an example computer system.

### DESCRIPTION OF EXAMPLE EMBODIMENTS

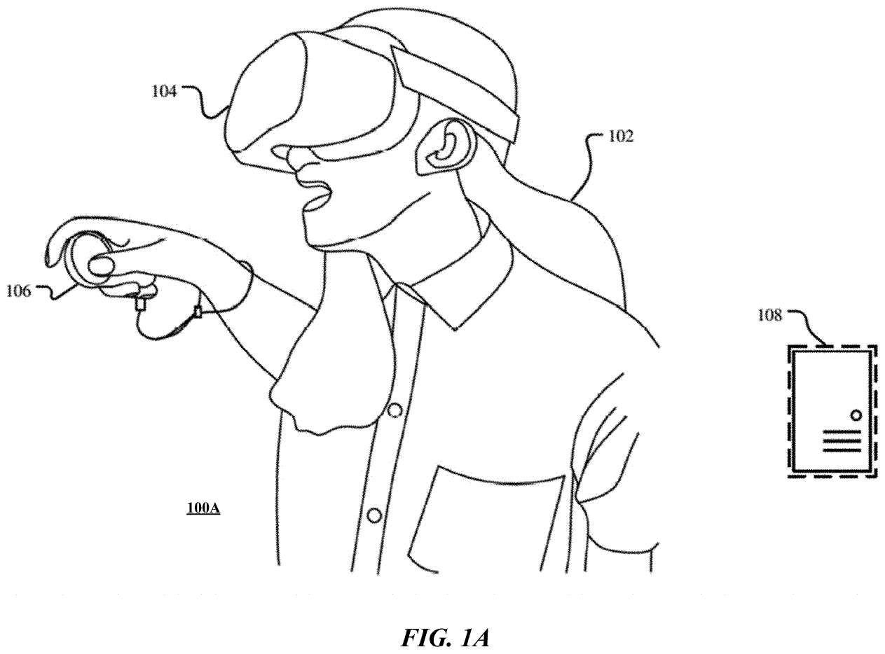

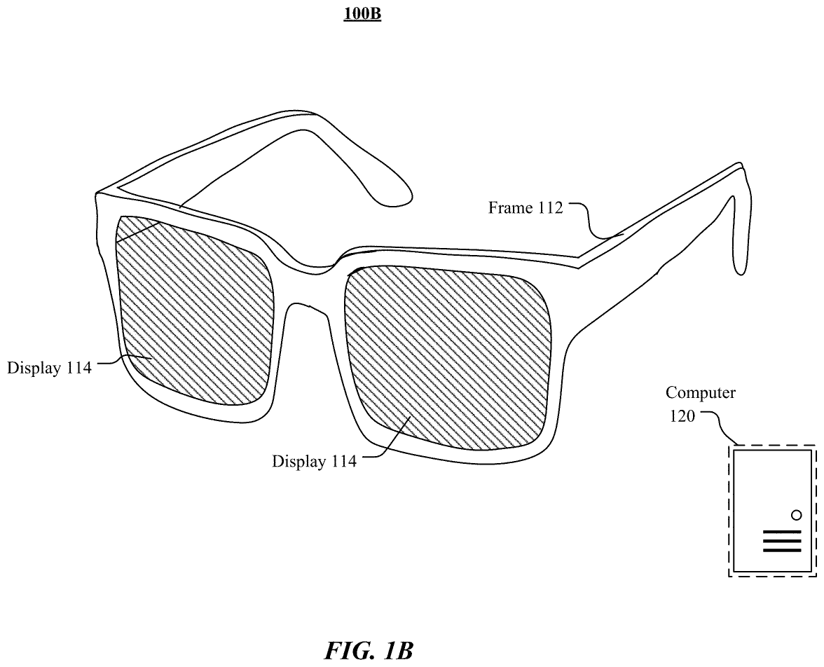

FIG. 1A illustrates an example artificial reality system 100 and user 102. In particular embodiments, the artificial reality system 100 may comprise a headset 104, a controller 106, and a computing system 108. A user 102 may wear the headset 104 that may display visual artificial reality content to the user 102. The headset 104 may include an audio device that may provide audio artificial reality content to the user 102. The headset 104 may include an eye tracking system to determine a vergence distance of the user 102. A vergence distance may be a distance from the user's eyes to objects (e.g., real-world objects or virtual objects in a virtual space) that the user's eyes are converged at. The headset 104 may be referred to as a head-mounted display (HMD). One or more controllers 106 may be paired with the artificial reality system 100. In particular embodiments one or more controllers 106 may be equipped with at least one inertial measurement units (IMUs) and infrared (IR) light emitting diodes (LEDs) for the artificial reality system 100 to estimate a pose of the controller and/or to track a location of the controller, such that the user 102 may perform certain functions via the controller 106. In particular embodiments the one or more controllers 106 may be equipped with one or more trackable markers distributed to be tracked by the computing system 108. The one or more controllers 106 may comprise a trackpad and one or more buttons. The one or more controllers 106 may receive inputs from the user 102 and relay the inputs to the computing system 108. The one or more controllers 106 may also provide haptic feedback to the user 102. The computing system 108 may be connected to the headset 104 and the one or more controllers 106 through cables or wireless connections. The one or more controllers 106 may include a combination of hardware, software, and/or firmware not explicitly shown herein so as not to obscure other aspects of the disclosure.

FIG. 1B illustrates an example augmented reality system 100B. The augmented reality system 100B may include a head-mounted display (HMD) 110 (e.g., glasses) comprising a frame 112, one or more displays 114, and a computing system 120. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The augmented reality system 100B may further include a controller comprising a trackpad and one or more buttons. The controller may receive inputs from users and relay the inputs to the computing system 120. The controller may also provide haptic feedback to users. The computing system 120 may be connected to the HMD 110 and the controller through cables or wireless connections. The computing system 120 may control the HMD 110 and the controller to provide the augmented reality content to and receive inputs from users. The computing system 120 may be a standalone host computer system, an on-board computer system integrated with the HMD 110, a mobile device, or any other hardware platform capable of providing artificial reality content to and receiving inputs from users.

Users of artificial reality systems often wish to traverse and experience areas beyond a particular room or area, for example and not by way of limitation, by moving throughout rooms or floors of a particular building, leaving the building and walking down a particular street, exploring a public space (e.g., a public park), or visiting another user's space (e.g., a second user's living room). As a user moves throughout these spaces, artificial reality systems must provide synchronized, continuous, and updated feature maps with low latency in order to provide a high quality, immersive, and enjoyable experience for users. A feature map may comprise a digital representation of a particular area that comprises multiple layers of map data. Map Data may include, for example and not by way of limitation, geometry and semantics of a particular environment (e.g., 3D meshes, point clouds, feature descriptors, coordinate frames, etc.), placement of virtual content that is displayed in the artificial reality environment (e.g., floating or anchored), organization of virtual content in the artificial reality environment (e.g., grouping by 2D or 3D plane), persistency of virtual content in the artificial reality environment (e.g., users can return to virtual content when they revisit a particular area), and privacy and sharing settings (e.g., users can share virtual content individually or collectively with a group of users based on one or more settings (e.g., based on vicinity, network connection settings, social network settings, etc.)).

In particular embodiments feature maps may be generated using data provided through a variety of mechanisms, including for example crowdsourced photos, video and image sequences, or pedestrian or vehicular apparatuses. For example, while a user of an artificial reality device experiences an area of a real environment, the artificial reality device may capture sensor data (e.g., images, LIDAR, location measurements, etc.) of the real environment from multiple viewpoints while the user is experiencing a particular area (e.g., a user's home, street, or public area). Using this data, the computing system can associate the captured data and recover the 3D geometry and appearance of the 3D scene using captured data from multiple viewpoints and output map data, which may contain multiple layers of information (e.g., localization maps, 3D meshes, semantic maps, depth maps, point clouds, feature descriptors, etc.) for the particular area. Computing systems can provide, index, and update the feature maps that correspond to a particular area for one or more users. In particular embodiments feature maps can be generated, stored, and updated on an artificial reality device (e.g., stored for offline use by the device).

To be most effective and valuable feature maps must be regularly updated to maintain accurate and up-to-date representations of the real environment they represent. These updates not only account for scene changes (e.g., relocated objects such as furniture and movement of dynamic objects such as people or pets), but also changing ambient conditions (e.g. day versus night, lights on versus off, etc.) that may impact the user's perception of the scene. One way to update and maintain the accuracy of map data for a particular area is to share and crowdsource feature maps or portions of feature maps among a plurality of users. The feature map or portions of feature maps generated by each user's artificial reality device may be directly shared with other users, or uploaded to a second computing system (e.g., a cloud or a server), where it can be accessed and downloaded by other users. In particular embodiments feature maps generated by a particular artificial reality device may also or alternatively be stored locally (e.g., on the user's artificial-reality device). Storing a feature map on a device is particularly advantageous for areas a particular user is more likely to revisit (e.g., their home, their neighborhood, etc.), so storing the corresponding feature map locally provides quick and convenient access without the need to download a feature map or portions of a feature map when a user revisits a particular area. Storing portions of a feature map locally on a user device may further enhance privacy of particular map areas (e.g., a bedroom or private area of a user's house).

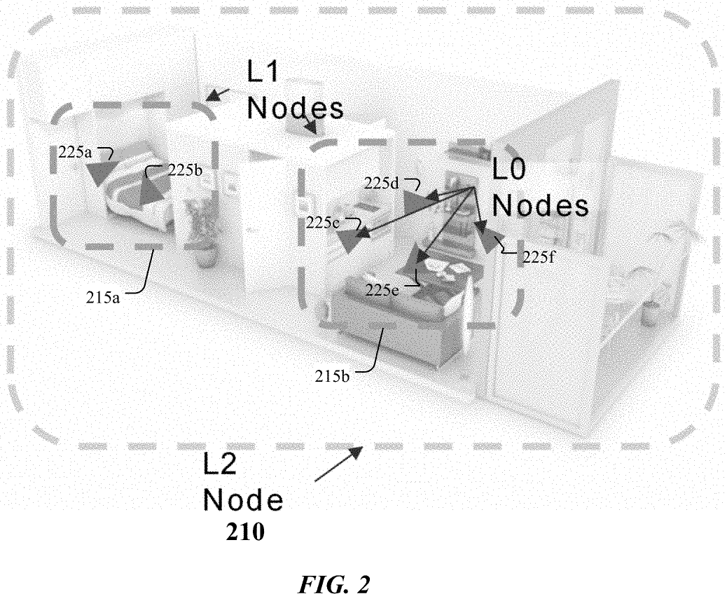

FIG. 2 illustrates a spatial representation of a feature map, which may include one or more subgraphs that compromise one or more nodes that define a particular area. In particular embodiments a feature map or subgraph for a particular area may comprise one or more nodes. Nodes may include one or more anchor points, feature descriptors, meshes, or other data as disclosed herein that describe a particular area with particular levels of detail. One or more nodes in the feature map may be defined by spatial relationships between one or more feature descriptors that correspond to a visible feature in a real environment captured by the device. For example, one or more nodes may be spatially structured and grouped based on the organization of the area they represent. For example, as illustrated in FIG. 2, an L2 node 210 may store and represent data for the feature map representing the entire floor of a house depicted in FIG. 2. Similarly, L1 nodes 215a and 215b may store and represent map data for different rooms on the floor of the house depicted in FIG. 2. L0 nodes 225a-225f may represent individual locations that comprise and represent one or more 3D point observations that were recorded by an artificial reality device at that particular location. Each observation may include, for example and not by way of limitation, one or more 3D points relative to the device, point descriptors, feature descriptors, camera calibration, and geographic location of the artificial reality device when the observation was recorded.

In particular embodiments there is no global coordinate system in the feature map to spatially relate the L0 nodes, L1 nodes, and L2 nodes, as depicted in FIG. 2. Rather, in certain embodiments each node is described and positioned relative to another node (e.g., L1 node 215a relative to L1 node 215b, L0 node 225a relative to L1 node 215, L1 node 215a relative to L2 node 210, etc.), which in turn relies on a relative graph structure and corresponding anchor points, feature descriptors, etc. that are visible within the user's environment to locate the user. In this manner, feature maps may permit a device to remember its pose and use the anchor points, feature descriptors, etc. improve its tracking accuracy without the need to consistently update the location of the device. For example, anchor points can permit a device to recover its geographic location if the feature map is tagged with accurate geographic coordinates. This structure conserves computing resources and power on the artificial reality device, and enables partial loading (e.g., the feature map can load as a user walks around a particular environment).

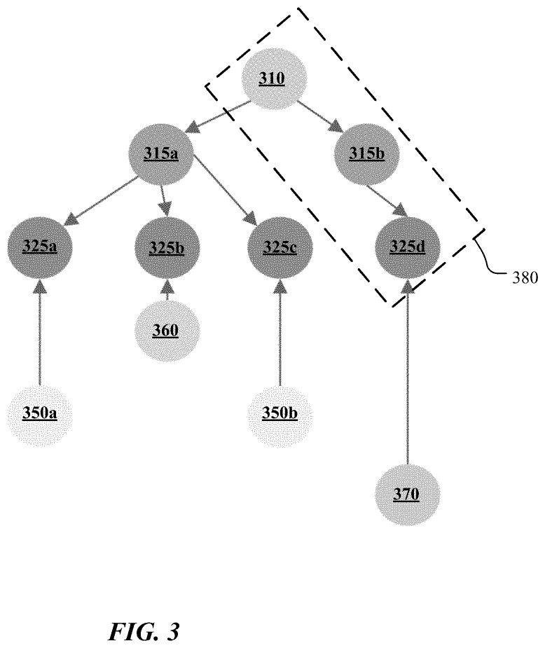

In particular embodiments, feature maps may be structured and stored in a hierarchical graph structure that provides for fast traversal and sharing across large areas. FIG. 3 illustrates an example hierarchical graph structure for a particular feature map. Each layer of the hierarchical graph structure consists of one or more nodes, as depicted in FIG. 3. For example. these nodes may represent a grouping of one or more feature descriptors or anchor points (e.g., leaf nodes (level 0 or L0 nodes) are anchors and high-level nodes (e.g. L2 nodes) represent a region/cluster of anchors)). As an example, L2 node 310, which for the graph structure depicted in FIG. 3 represents the largest area of the feature map, may be stored at the top of the hierarchical structure, and connected to L1 nodes 315a and 315b, which represent smaller areas of the feature map. L1 nodes may be connected to L0 nodes 325a-325d. In particular embodiments, the hierarchical graph structure may further comprise one or more individual anchor points 350a and 350b, geo anchor points 360, or anchor surface points 370, as described herein.

This hierarchical storage structure reduces strain on computing resources by limiting the density of stored data and streaming only parts of feature maps (e.g., particular nodes) between the disk and memory as needed. The structure also permits easily sharing particular portions of the map, which may be referred to herein as a subgraph, thereby maintaining user privacy of sensitive areas of the map. For example, referring to FIG. 3, a user may wish to only share certain elements of the feature map comprising L0 node 325d. To accommodate this, only subgraph 380 comprising L2 node 310, L1 node 315b and L0 node 325d may be shared with other users. The hierarchical structure further permits a device to quickly determine and recover its geographic location and improve tracking accuracy based on the relative locational structure between each node in the feature map or shared subgraph, which allows for the device to localize its position without persistently relying on GPS by comparing the stored feature descriptors or anchor points on the feature map on the device to the currently observed feature descriptors. Because the location of each anchor point and node is relative in the map structure, the map fidelity of the neighboring/distant visual anchors may worsen with increased distance. However, at greater distances the user is less likely to care about fidelity, making this structure amenable to AR applications. As the user gets closer to these distant anchor points, the device can re-orient against the feature descriptors of these anchor points, and the spatial pose of the AR object becomes more accurate. Although FIG. 3 depicts a limited set of nodes, in particular embodiments the hierarchical structure disclosed herein may comprise any number of nodes and any number of levels of nodes (e.g., L0, L1, L2, L3 . . . Ln) to accommodate any size of map and level of detail provided.

As previously discussed, in particular embodiments a feature map may comprise, for example and not by way of limitation, information regarding the geometry and semantics of a particular area in an environment. In particular embodiments the feature map may comprise one or more feature descriptors that can be used to identify, locate, describe, and differentiate one or more features in an environment, for example and not by way of limitation an object or a particular area of an object (e.g., a corner or edge). Feature descriptors can also be utilized for tracking an environment as a user or artificial-reality device moves through the space, for example by localizing the user or the artificial-reality device in the environment, or by tracking one or more features in the environment (e.g., an object) as the user or an artificial-reality device moves throughout the environment. Generally, more feature descriptors for a particular environment provides a larger model that results in more accurate tracking in an environment. Feature descriptors may include varying levels of detail (e.g., precision, accuracy, etc.). More robust and detailed feature descriptors may be able to permit more accurate functionality (e.g., identification, tracking, etc.) and thus provide a more-immersive artificial reality experience despite challenging environmental conditions (e.g., low lighting, less texture) or changes to viewing angles that may alter the appearance of the environment.

In particular embodiments, map data may further comprise one or more anchor points. An anchor point is a physical address in space which enables users to place and display virtual content to a real object in the artificial reality environment. Anchor points further facilitate placement and persistency of virtual content (e.g., floating, fixed, or magnetized to a surface to aid placement), and permits users to place virtual content in the exact desired place in the real world. Anchor points with known locations, as described herein, can be used to identify, locate, and differentiate one or more features in an environment, and allow for localization and tracking of an artificial-reality device in the artificial reality environment.

In particular embodiments anchor points can be clustered to further permit users to easily manage and share virtual content. For example, anchor points can be managed individually, or can be grouped by surface (e.g., a 2D plane), space (e.g., a 3D volume, or collection of content), or object (e.g., an object at a time it is shared); Anchor points further permit users to discover content relevant to them and their current location. For example, an artificial reality device may discover nearby anchor points using coarse localization when a device is in standby (GPS, WPS, BLE), and use precise location (e.g., SLAM) is better when device is on. This permits users to quickly discover and return to virtual content when they experience a particular artificial reality environment. In particular embodiments anchor points may be linked to an L0 node, as depicted in FIG. 3.

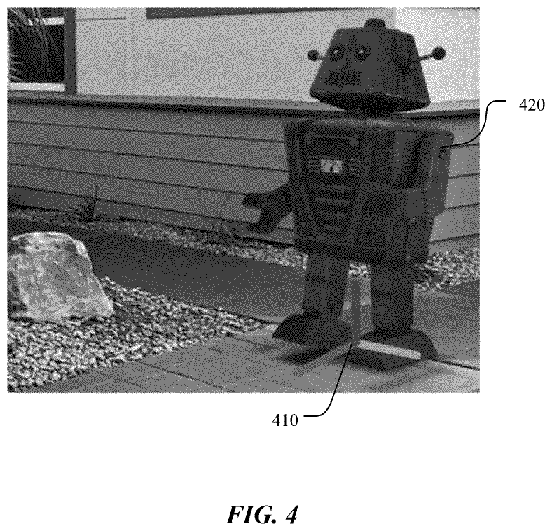

FIG. 4 illustrates an example anchor point for facilitating placement of a virtual object in an artificial reality environment. As an example, a user may create and place an anchor point 410 representing a virtual object of a robot 420 in an artificial reality environment. The anchor point 410 may include information about the location, persistency, and other attributes of the virtual content as described herein. As another example, a business may create and attach an anchor point for a virtual advertisement (e.g., “Spencer's Widget Store! Discount Widgets! Refurbished— 30% Off”) at a particular location in the real environment (e.g., a bus stop at the corner of 5^{th} Street and Main Street). As another example, a user may create and attach an anchor point that provides navigational or point-of-interest information to users (e.g., “Golden Gate Bridge— ½ Mile Ahead”, or “Haunted House—1234 Elm Street—Turn left 1 mi. ahead at the corn field”). Anchor points can further comprise data that can be used to define the location, orientation, and behavior (e.g., the persistence) of virtual content in the artificial reality environment. In particular embodiments anchor points may be static relative to an object (e.g., virtual content attached to a billboard, building, bridge, etc.) in the real environment. Anchor points may be further utilized to facilitate localization of an artificial reality device in the artificial reality environment. Anchor points may also identify or indicate objects or points of interest in an artificial reality environment.

In particular embodiments anchor points may be further defined or sub-categorized by their characteristics. For example, an anchor point that attaches virtual content to a point in free space relative to one or more other anchor points or feature descriptors may be referred to as a spatial anchor point. A spatial anchor point may comprise one or more features of an anchor point and further be defined by both the position and orientation of the virtual content (e.g., 6 degrees of freedom). In particular embodiments spatial anchor points may support displaying the virtual content as “floating” in the air at a particular point in free space with low or high accuracy.

As another example, an anchor point that attaches virtual content to a fixed point in free space based on an absolute location (e.g., based on absolute coordinates (latitude, longitude, altitude)) may be referred to as a geo anchor point. A geo anchor point may comprise one or more features of an anchor point and further define both the position and orientation of the virtual content (e.g., 6 degrees of freedom) based on the particular absolute coordinates (e.g. the latitude, longitude, bearing) for the geo anchor point. In particular embodiments geo anchor points may support displaying the virtual content as “floating” in the air at a particular point in free space with low or high accuracy. An advantage of geo anchor points is the ability to locate and place content in an environment without the need for detailed map coverage due to the fixed location (e.g., coordinates) associated with the geo anchor point. Geo anchor points may require high accuracy location services on the user device (e.g., the HMD) and user movement in order to obtain location and orientation accuracy of the user relative to a geo anchor point. Therefore, geo anchor points may be better suited for outdoor environments or experiences that can tolerate errors that may occur due to the location services of the user device (e.g., experiences that can tolerate 1-5 meter error in placement of virtual content). For example and not by way of limitation, geo anchor points may facilitate content discovery, for example POI and location discovery in outdoor environments, navigation applications, and/or scavenger hunt or similar gaming applications.

Anchor points as described herein can be generated and shared with a plurality of users. In particular embodiments users may be able to create, detect, discover, locate, track, search, share, or delete particular visual anchors. As an example, a user may search for a particular visual anchor based on, for example and not by way of limitation, the type of virtual content (e.g., an advertisement, interest point, coupon, object, etc.), distance from the user, etc. Alternatively, users may be automatically notified of anchor points based on, for example and not by way of limitation, the type of virtual content (e.g., an advertisement, interest point, coupon, object, etc.), distance from the user, or a user's past interests or activities (e.g., if a user has previously visited Spencer's Widget Store, or has expressed an interest in widgets, they may be automatically notified of the anchor point corresponding to the virtual advertisement for discount widgets at Spencer's Widget Store).

In particular embodiments users may wish to share portions of feature maps, related map data, feature descriptors, anchor points, virtual objects, virtual surfaces, collections of virtual objects, or similar data with other users or devices. In particular embodiments a feature map or map data may default to private after being generated, but can be directly shared with another user or device. Alternatively, a feature map or map data may be uploaded or stored on a cloud server that permits sharing with a specified group of users, or alternatively is accessible by other users for download. An advantage to storing feature maps locally on the device is the conservation of computing resources. For example, if a user of an HMD frequently visits a particular area (e.g., their home), storing the corresponding feature map on their device reduces the need to recurringly download the corresponding feature map. However, for larger areas (e.g., a park or shopping mall) the HMD may have limited storage capacity to keep store the appropriate feature map on the device.

Privacy is also an important consideration when sharing and crowdsourcing 3D feature maps and data among users. For example, users could simply directly share image data of real environments with one another, which would allow each artificial-reality device to process the image and generate 3D map data (e.g., feature descriptors) that is particularized for the capabilities of the particular device. Yet such an approach would compromise privacy by requiring sharing and storing personalized image data with other users. For example, users may prefer not to share images that are captured while they experience an environment, which may permit others to ascertain the location or activities of the user. As another example, a user may prefer not to share images of their bedroom, bathroom, or other private areas of their home. Accordingly, there is a need to share feature maps and data amongst users without sharing and storing personalized data, such as images.

To satisfy these privacy considerations, in particular embodiments feature maps, or portions of feature maps, may be easily shared between devices using the hierarchical graph structure. Returning to FIG. 3, by only transmitting and sharing portions of the hierarchical graph structure for a particular feature map (e.g., subgraph 380), which may provide varying levels of spatial extent and detail, users can keep portions of feature maps private and only transmit the map data that is needed to permit other users to experience a particular area. As an example and not by way of limitation, a feature map depicted in FIG. 3 represents a particular floor of User A's house, L2 node 310 may represent the particular floor, L1 nodes 315a and 315b may represent particular rooms on that floor (e.g., a bedroom and a living room, respectively). User A may wish to share only portions of their feature map with User B, for example User A may wish to share only L1 node 315b (and connected L0 nodes) representing the living room, while keeping L1 node 315a (and connected L0 nodes) private. The hierarchical structure provides the ability to only transmit the relevant portions of the feature map, for example relevant subgraph 380, thereby minimizing communications and maximizing privacy.

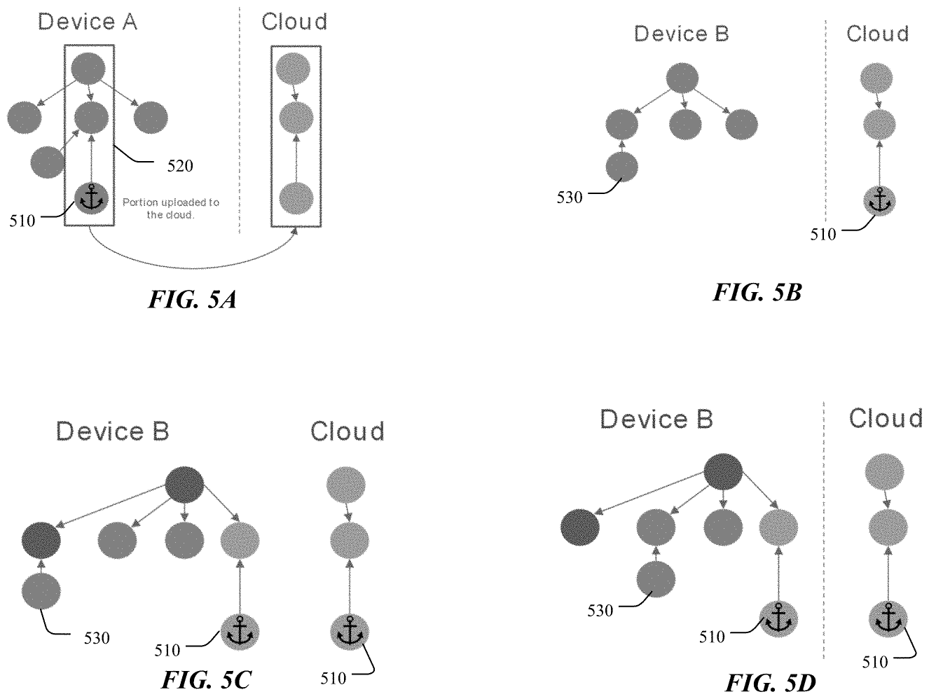

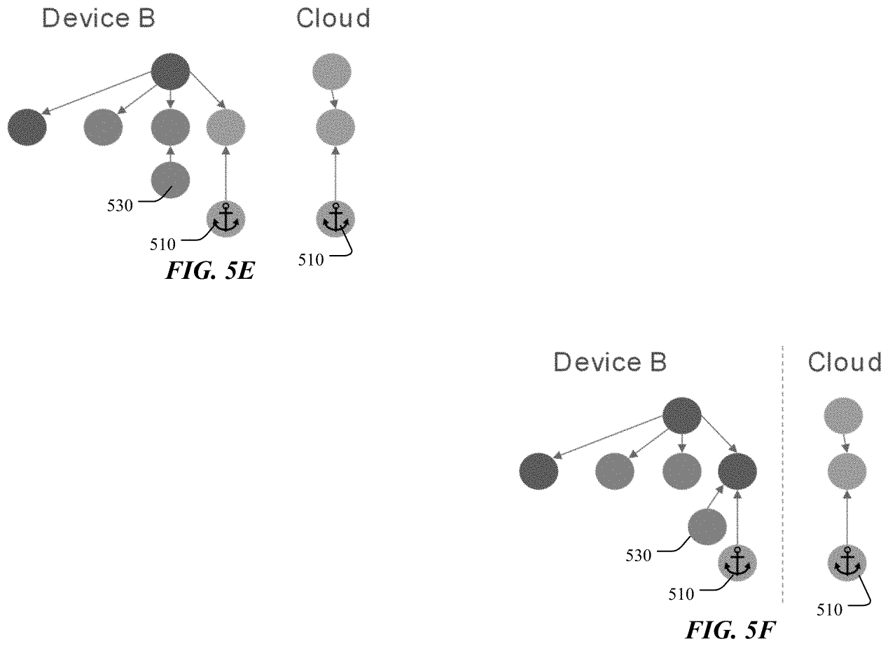

FIG. 5A-5F illustrate a sample process for sharing and merging feature maps between artificial reality devices. In FIG. 5A, Device A generates an anchor point 510, which is stored locally on the device, and also transmits the relevant subgraph 520 (e.g., anchor point 510 and associated nodes, which may comprises one or more anchor points or feature descriptors) to the cloud via an upload. As depicted in FIG. 5A, the map data uploaded to the cloud may be a subgraph, which comprises the anchor point of interest and one or more other portions of the feature map in order to locate and position the anchor point in the artificial reality environment (e.g., the hierarchical nodes directly or indirectly connected to the anchor point, which may comprise one or more feature descriptors, anchor points, etc.). The cloud then stores the transmitted data for use by other devices.

As illustrated in FIG. 5B, Device B, which has its own feature map stored on the device that differs from the feature map on Device A, may query for the relevant anchor point 510 created by Device A. This query may be based on one or more criteria, for example and not by way of limitation, Device B may approach an area occupied by Device A, User B and User A may have previously shared map data with each other, User B may search for a particular anchor point (e.g., searches for directions, a particular POI, etc.), the prior purchase history or searches of User B, popular searches for other users in the area, etc. As depicted in FIG. 5B, Device B may have a feature map stored locally on their device, which is similar, but not identical (e.g., does not include the anchor point of interest) to the feature map stored on Device A. A computing system associated with the cloud can extract and transmit the relevant stored subgraph 520 to Device B based on the queried anchor point 510. In particular embodiments the subgraph consists of L1 node (or nodes) around the current location of the device to enable localization of the spatial anchor on Device B. The received subgraph 520 can allow the computing system to update the feature map stored on Device B based on a comparison between one or more feature descriptors stored in the feature map stored on Device B and one or more feature descriptors in subgraph 520.

As illustrated in FIG. 5C, the relevant anchor point 510 and subgraph of the feature map are received by Device B and merged into the feature map stored on Device B. Two methods are provided for merging the received anchor point and subgraph into the feature map stored on Device B. In some embodiments, Device B updates the local map stored on the device by merging the subgraph with the feature map stored on Device B using a relocalization process. For example, Device B may recognize a loop closure between the stored feature map and the received subgraph by observing one or more feature descriptors in the artificial reality environment, and merging one or more nodes (e.g., an anchor point) by comparing and determining the spatial relationship between the feature descriptors that were transmitted as part of the subgraph 510 that are associated with the received anchor point, and one or more visible feature descriptors in the feature map on Device B that can be observed from Device B's current location. This allows Device B to connect the received subgraph to the main feature map by comparing the received feature descriptors with one or more feature descriptors stored on the device. This embodiment is depicted in FIG. 5C (e.g., the L1 node In the subgraph has been merged with an L1 node in the feature map stored on Device B. In FIGS. 5D-5F, Device B has determined the spatial relationship between existing L0 node 530 and anchor point 510 according to the methods described herein. In particular embodiments, comparing more feature descriptors (e.g., for a real environment that has a larger amount of map data) may result in the anchor point being more accurately placed in the real environment, resulting in less error in location.

In an alternative embodiment, Device B could merge the subgraph without relocalization. For example, if the feature descriptors of the received anchor point are not observable, Device B could use past observations of feature descriptors in the artificial reality environment stored on the device to match these previous observations with the received anchor point. As an example, the received anchor point could be 3 meters away from where Device B was located an hour ago).

In particular embodiments, a pose of a device can be determined using the merged map. For example, the pose of Device B in the real environment can be determined using the merged map, relative to a particular feature descriptor, anchor point, etc. in the merged map. Once merged, virtual content can be rendered and displayed to a user of Device B using the shared portion of the subgraph. For example, virtual content may be rendered based on a determined pose of Device B and one or more spatial relationships, for example and not by way of limitation, a spatial relationship between a particular feature descriptor and an anchor point in the merged feature map on Device B. In particular embodiments, Device B may persistently or recurringly adjust the anchor points as the user of Device B approaches one or more anchor points in the artificial reality environment. For example, the computing system may determine that Device B has moved to a second location, where the second location is nearer to the received anchor point than a previous location. For example, as illustrated in FIGS. 5E and 5F, as Device B approaches toward a particular anchor point, the computing system can re-recognize a loop closure and adjust one or more graph nodes to provide a better pose of the anchor point by comparing the one or more feature descriptors received from the update to one or more feature descriptors available at the updated location of Device B. Adjusting the position of the anchor point may be based on comparing the one or more feature descriptors in the received subgraph with one or more feature descriptors present at the second location. In particular embodiments, as the device moves to locations that are nearer to the anchor point, more feature descriptors will be available to in order to accurately adjust the position of the anchor point. Adjustment may become particularly important as a user of a device approaches or seeks to interact with a particular anchor point in the artificial reality environment. For example, when a user of a device is distanced from the anchor point (e.g., more than 10 meters away) any errors in the positioning of the anchor point are often insignificant and imperceivable to the user. This is likely to occur when a device first downloads map data from the cloud. However, as the user approaches the particular point after merging the data with the feature map, these errors may become significant. Adjusting as the user approaches one or more anchor points creates an accurate and more immersive experience.

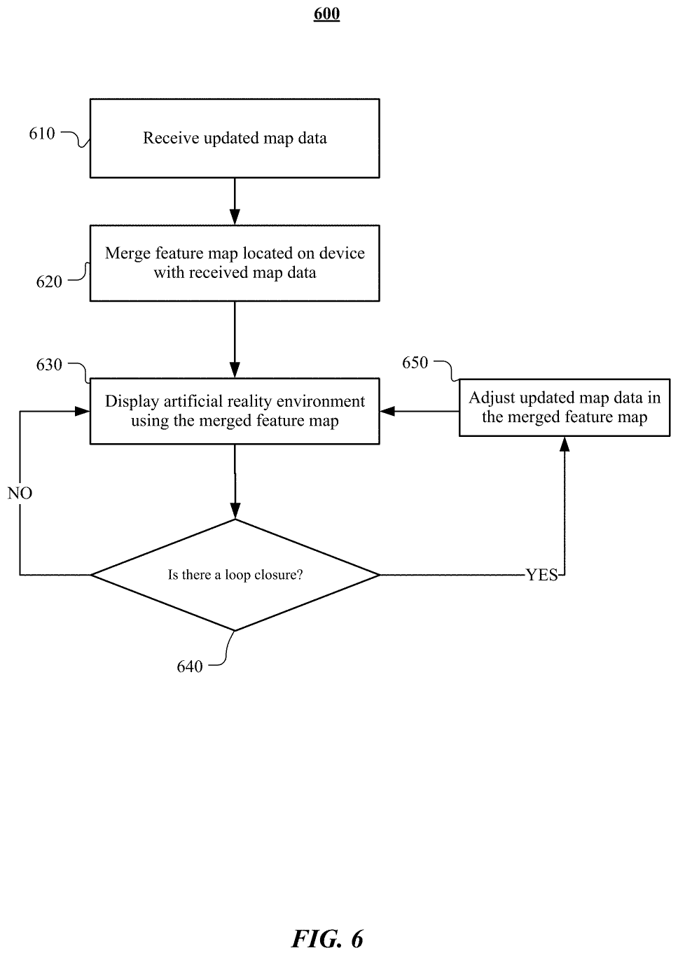

FIG. 6 illustrates a sample process 600 for updating a feature map stored on an artificial reality device. At step 610, an artificial reality device may receive updated map data for an environment. The updated map data may comprise one or more anchor points and other information associated with the environment, for example and not by way of limitation, feature descriptors, meshes, or other information that may describe the environment. The update may be received from a second artificial reality device, or they may be received from a cloud server or similar apparatus that stores feature map data from a plurality of artificial reality devices.

At step 620, the artificial reality device may merge a feature map stored on the device with the received updated map data. In particular embodiments, the device could use past observations of feature descriptors in the artificial reality environment stored on the device to match the previous observations with the received updated map data. In some embodiments, merging the received update with the feature map on the device may additionally or alternatively be done using a relocalization process, which may involve comparing one or more feature points or other information about the environment. At step 630, after merging the updated map data to the feature, the device may display the artificial reality environment to the user of the artificial reality device using the merged feature map.

At step 640, the device may periodically determine if a loop closure exists in the updated map. A loop closure may result from limited feature descriptors or other limited information about the environment that prevents the updated map data from being accurately merged with the feature map. A loop closure may result in anchor points or virtual content being incorrectly placed. At great distances (e.g., more than 10 meters) from the virtual content, this may be imperceivable or insignificant, but as a user approaches content, it may become apparent and detract from the artificial reality experience. Thus, in particular embodiments the computing system may determine if a loop closure exists based on the device becoming closer to virtual content (e.g., an anchor point) or when it reaches a threshold minimum distance from the virtual content.

At step 650, the computing system may update the feature map to reduce or eliminate a determined loop closure. For example, the device may compare information (e.g., feature descriptors) in the updated map data to one or more feature descriptors at a second location, for example a location closer to the anchor point. At this second location, there may be more feature descriptors that permit for a more accurate adjustment of the updated map data into the feature map. Alternatively, if no loop closure is detected, the computing system may return to step 630 and continue to monitor for a loop closure between the feature map on the device and the received updated map data.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 5 occurring in any suitable order. Moreover, although this disclosure describes and illustrates an example process for updating a feature map stored on an artificial reality device, including the particular steps of the method of FIG. 6, this disclosure contemplates any suitable process for updating a feature map stored on an artificial reality device, including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

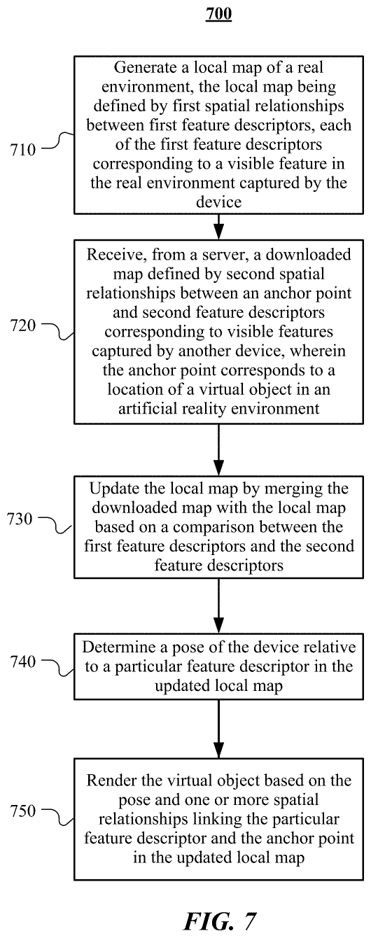

FIG. 7 illustrates an example method 700 for displaying virtual objects in an artificial reality environment based on a merged map. At step 710 a computing system associated with a device may generate a local map of a real environment, the local map being defined by first spatial relationships between first feature descriptors, each of the first feature descriptors corresponding to a visible feature in the real environment captured by the device.

At step 720 the computing system may receive, from a server, a downloaded map defined by second spatial relationships between an anchor point and second feature descriptors corresponding to visible features captured by another device, wherein the anchor point corresponds to a location of a virtual object in an artificial reality environment.

At step 730, the computing system may update the local map by merging the downloaded map with the local map based on a comparison between the first feature descriptors and the second feature descriptors

At step 740 the computing system may determine a pose of the device relative to a particular feature descriptor in the updated local map.

At step 750, the computing system may render the virtual object based on the pose and one or more spatial relationships linking the particular feature descriptor and the anchor point in the updated local map.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for displaying virtual objects in an artificial reality environment based on a merged map, including the particular steps of the method of FIG. 7, this disclosure contemplates any suitable method for displaying virtual objects in an artificial reality environment based on a merged map, including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

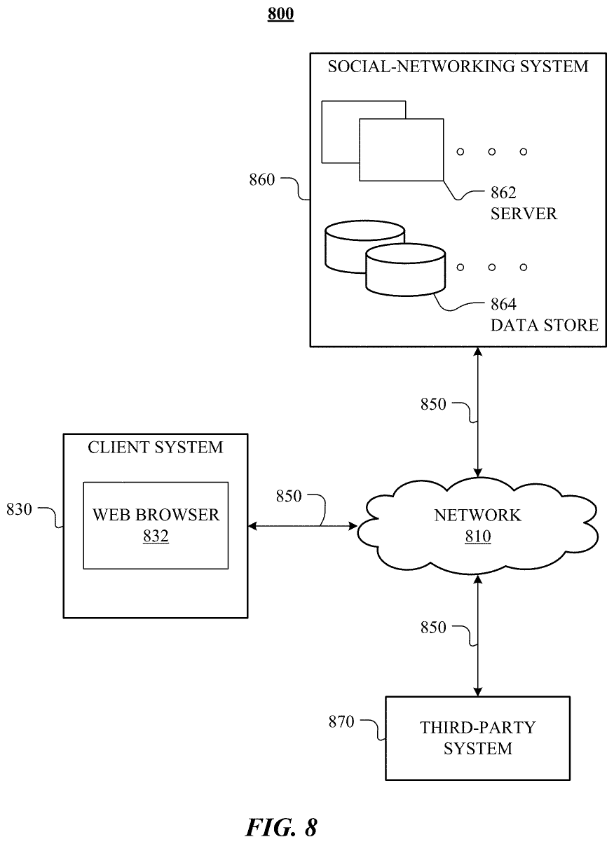

FIG. 8 illustrates an example network environment 800 associated with a social-networking system. Network environment 800 includes a client system 830, a social-networking system 860, and a third-party system 870 connected to each other by a network 810. Although FIG. 8 illustrates a particular arrangement of client system 830, social-networking system 860, third-party system 870, and network 810, this disclosure contemplates any suitable arrangement of client system 830, social-networking system 860, third-party system 870, and network 810. As an example and not by way of limitation, two or more of client system 830, social-networking system 860, and third-party system 870 may be connected to each other directly, bypassing network 810. As another example, two or more of client system 830, social-networking system 860, and third-party system 870 may be physically or logically co-located with each other in whole or in part. Moreover, although FIG. 8 illustrates a particular number of client systems 830, social-networking systems 860, third-party systems 870, and networks 810, this disclosure contemplates any suitable number of client systems 830, social-networking systems 860, third-party systems 870, and networks 810. As an example and not by way of limitation, network environment 800 may include multiple client system 830, social-networking systems 860, third-party systems 870, and networks 810.

This disclosure contemplates any suitable network 810. As an example and not by way of limitation, one or more portions of network 810 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 810 may include one or more networks 810.

Links 850 may connect client system 830, social-networking system 860, and third-party system 870 to communication network 810 or to each other. This disclosure contemplates any suitable links 850. In particular embodiments, one or more links 850 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 850 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 850, or a combination of two or more such links 850. Links 850 need not necessarily be the same throughout network environment 800. One or more first links 850 may differ in one or more respects from one or more second links 850.

In particular embodiments, client system 830 may be an electronic device including hardware, software, or embedded logic components or a combination of two or more such components and capable of carrying out the appropriate functionalities implemented or supported by client system 830. As an example and not by way of limitation, a client system 830 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 830. A client system 830 may enable a network user at client system 830 to access network 810. A client system 830 may enable its user to communicate with other users at other client systems 830.

In particular embodiments, client system 830 may include a web browser 832, and may have one or more add-ons, plug-ins, or other extensions. A user at client system 830 may enter a Uniform Resource Locator (URL) or other address directing the web browser 832 to a particular server (such as server 862, or a server associated with a third-party system 870), and the web browser 832 may generate a Hyper Text Transfer Protocol (HTTP) request and communicate the HTTP request to server. The server may accept the HTTP request and communicate to client system 830 one or more Hyper Text Markup Language (HTML) files responsive to the HTTP request. Client system 830 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, social-networking system 860 may be a network-addressable computing system that can host an online social network. Social-networking system 860 may generate, store, receive, and send social-networking data, such as, for example, user-profile data, concept-profile data, social-graph information, or other suitable data related to the online social network. Social-networking system 860 may be accessed by the other components of network environment 800 either directly or via network 810. As an example and not by way of limitation, client system 830 may access social-networking system 860 using a web browser 832, or a native application associated with social-networking system 860 (e.g., a mobile social-networking application, a messaging application, another suitable application, or any combination thereof) either directly or via network 810. In particular embodiments, social-networking system 860 may include one or more servers 862. Each server 862 may be a unitary server or a distributed server spanning multiple computers or multiple datacenters. Servers 862 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 862 may include hardware, software, or embedded logic components or a combination of two or more such components for carrying out the appropriate functionalities implemented or supported by server 862. In particular embodiments, social-networking system 860 may include one or more data stores 864. Data stores 864 may be used to store various types of information. In particular embodiments, the information stored in data stores 864 may be organized according to specific data structures. In particular embodiments, each data store 864 may be a relational, columnar, correlation, or other suitable database. Although this disclosure describes or illustrates particular types of databases, this disclosure contemplates any suitable types of databases. Particular embodiments may provide interfaces that enable a client system 830, a social-networking system 860, or a third-party system 870 to manage, retrieve, modify, add, or delete, the information stored in data store 864.

In particular embodiments, social-networking system 860 may store one or more social graphs in one or more data stores 864. In particular embodiments, a social graph may include multiple nodes—which may include multiple user nodes (each corresponding to a particular user) or multiple concept nodes (each corresponding to a particular concept)—and multiple edges connecting the nodes. Social-networking system 860 may provide users of the online social network the ability to communicate and interact with other users. In particular embodiments, users may join the online social network via social-networking system 860 and then add connections (e.g., relationships) to a number of other users of social-networking system 860 to whom they want to be connected. Herein, the term “friend” may refer to any other user of social-networking system 860 with whom a user has formed a connection, association, or relationship via social-networking system 860.

In particular embodiments, social-networking system 860 may provide users with the ability to take actions on various types of items or objects, supported by social-networking system 860. As an example and not by way of limitation, the items and objects may include groups or social networks to which users of social-networking system 860 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 860 or by an external system of third-party system 870, which is separate from social-networking system 860 and coupled to social-networking system 860 via a network 810.

In particular embodiments, social-networking system 860 may be capable of linking a variety of entities. As an example and not by way of limitation, social-networking system 860 may enable users to interact with each other as well as receive content from third-party systems 870 or other entities, or to allow users to interact with these entities through an application programming interfaces (API) or other communication channels.

In particular embodiments, a third-party system 870 may include one or more types of servers, one or more data stores, one or more interfaces, including but not limited to APIs, one or more web services, one or more content sources, one or more networks, or any other suitable components, e.g., that servers may communicate with. A third-party system 870 may be operated by a different entity from an entity operating social-networking system 860. In particular embodiments, however, social-networking system 860 and third-party systems 870 may operate in conjunction with each other to provide social-networking services to users of social-networking system 860 or third-party systems 870. In this sense, social-networking system 860 may provide a platform, or backbone, which other systems, such as third-party systems 870, may use to provide social-networking services and functionality to users across the Internet.

In particular embodiments, a third-party system 870 may include a third-party content object provider. A third-party content object provider may include one or more sources of content objects, which may be communicated to a client system 830. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 860 also includes user-generated content objects, which may enhance a user's interactions with social-networking system 860. User-generated content may include anything a user can add, upload, send, or “post” to social-networking system 860. As an example and not by way of limitation, a user communicates posts to social-networking system 860 from a client system 830. Posts may include data such as status updates or other textual data, location information, photos, videos, links, music or other similar data or media. Content may also be added to social-networking system 860 by a third-party through a “communication channel,” such as a newsfeed or stream.

In particular embodiments, social-networking system 860 may include a variety of servers, sub-systems, programs, modules, logs, and data stores. In particular embodiments, social-networking system 860 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 860 may also include suitable components such as network interfaces, security mechanisms, load balancers, failover servers, management-and-network-operations consoles, other suitable components, or any suitable combination thereof. In particular embodiments, social-networking system 860 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 860 to one or more client systems 830 or one or more third-party system 870 via network 810. The web server may include a mail server or other messaging functionality for receiving and routing messages between social-networking system 860 and one or more client systems 830. An API-request server may allow a third-party system 870 to access information from social-networking system 860 by calling one or more APIs. An action logger may be used to receive communications from a web server about a user's actions on or off social-networking system 860. In conjunction with the action log, a third-party-content-object log may be maintained of user exposures to third-party-content objects. A notification controller may provide information regarding content objects to a client system 830. Information may be pushed to a client system 830 as notifications, or information may be pulled from client system 830 responsive to a request received from client system 830. Authorization servers may be used to enforce one or more privacy settings of the users of social-networking system 860. A privacy setting of a user determines how particular information associated with a user can be shared. The authorization server may allow users to opt in to or opt out of having their actions logged by social-networking system 860 or shared with other systems (e.g., third-party system 870), such as, for example, by setting appropriate privacy settings. Third-party-content-object stores may be used to store content objects received from third parties, such as a third-party system 870. Location stores may be used for storing location information received from client systems 830 associated with users. Advertisement-pricing modules may combine social information, the current time, location information, or other suitable information to provide relevant advertisements, in the form of notifications, to a user.

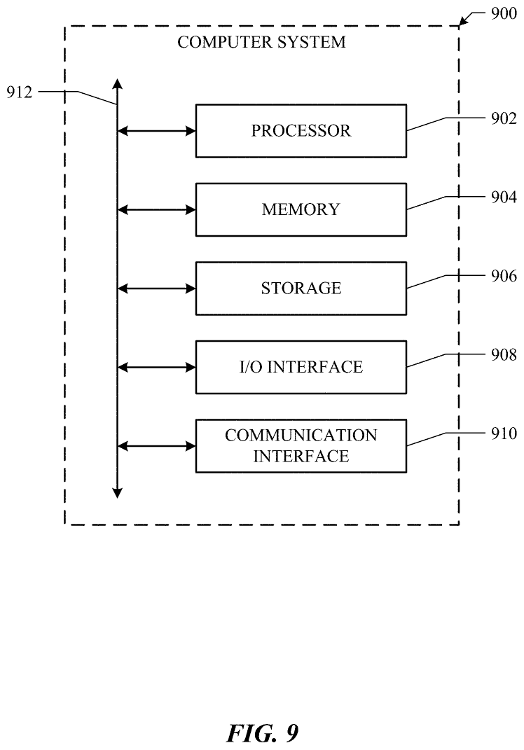

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system associated with a device:
generating a local map of a real environment, the local map being defined by first spatial relationships between first feature descriptors, each of the first feature descriptors corresponding to a visible feature in the real environment captured by the device;
receiving, from a server, a downloaded map defined by second spatial relationships between an anchor point and second feature descriptors corresponding to visible features captured by a second device, wherein the anchor point corresponds to a location of a virtual object in an artificial reality environment;
updating the local map by merging the downloaded map with the local map based on a comparison between the first feature descriptors and the second feature descriptors;
determining a pose of the device relative to a particular feature descriptor in the updated local map;
rendering the virtual object based on the pose and one or more spatial relationships linking the particular feature descriptor and the anchor point in the updated local map.

2. The method of claim 1, wherein determining the pose of the device comprises comparing one or more of the first feature descriptors or the second feature descriptors to a current viewpoint of the device.

3. The method of claim 1, wherein the local map is stored in a hierarchical graph structure comprising one or more subgraphs.

4. The method of claim 1, wherein the downloaded map comprises one or more subgraphs of a second local map stored on the second device.

5. The method of claim 1, wherein the downloaded map is received based on a current location of the device.

6. The method of claim 1, wherein the local map is stored on the device.

7. The method of claim 1, wherein the anchor point is a spatial anchor point, a geo anchor point, or an object anchor.

8. One or more computer-readable non-transitory storage media embodying software that is operable when executed to:
generate a local map of a real environment, the local map being defined by first spatial relationships between first feature descriptors, each of the first feature descriptors corresponding to a visible feature in the real environment captured by the device;
receive, from a server, a downloaded map defined by second spatial relationships between an anchor point and second feature descriptors corresponding to visible features captured by a second device, wherein the anchor point corresponds to a location of a virtual object in an artificial reality environment;
update the local map by merging the downloaded map with the local map based on a comparison between the first feature descriptors and the second feature descriptors;
determine a pose of the device relative to a particular feature descriptor in the updated local map;
render the virtual object based on the pose and one or more spatial relationships linking the particular feature descriptor and the anchor point in the updated local map.

9. The media of claim 7, wherein the determination of the pose of the device comprises comparing one or more of the first feature descriptors or the second feature descriptors to a current viewpoint of the device.

10. The media of claim 7, wherein the local map is stored in a hierarchical graph structure comprising one or more subgraphs.

11. The media of claim 7, wherein the downloaded map comprises one or more subgraphs of a second local map stored on the second device.

12. The media of claim 7, wherein the downloaded map is received based on a current location of the device.

13. The media of claim 7, wherein the local map is stored on the device.

14. The media of claim 7, wherein the anchor point is a spatial anchor point, a geo anchor point, or an object anchor.

15. A system comprising:
one or more processors; and
one or more computer-readable non-transitory storage media coupled to one or more of the processors and comprising instructions operable when executed by one or more of the processors to cause the system to:
generate a local map of a real environment, the local map being defined by first spatial relationships between first feature descriptors, each of the first feature descriptors corresponding to a visible feature in the real environment captured by the device;
receive, from a server, a downloaded map defined by second spatial relationships between an anchor point and second feature descriptors corresponding to visible features captured by a second device, wherein the anchor point corresponds to a location of a virtual object in an artificial reality environment;
update the local map by merging the downloaded map with the local map based on a comparison between the first feature descriptors and the second feature descriptors;
determine a pose of the device relative to a particular feature descriptor in the updated local map;
render the virtual object based on the pose and one or more spatial relationships linking the particular feature descriptor and the anchor point in the updated local map.

16. The system of claim 15, wherein the determination of the pose of the device comprises comparing one or more of the first feature descriptors or the second feature descriptors to a current viewpoint of the device.

17. The system of claim 15, wherein the local map is stored in a hierarchical graph structure comprising one or more subgraphs.

18. The system of claim 15, wherein the downloaded map comprises one or more subgraphs of a second local map stored on the second device.

19. The system of claim 15, wherein the downloaded map is received based on a current location of the device.

20. The system of claim 15, wherein the local map is stored on the device.
